(19) United States
(12) Patent Application Publication
(10) Pub. No.: US 2017/0018268 A1
(43) Pub. Date: Jan. 19, 2017

(54) SYSTEMS AND METHODS FOR UPDATING A LANGUAGE MODEL BASED ON USER INPUT

(71) Applicant: Nuance Communications, Inc., Burlington, MA (US)

(72) Inventor: Holger Quast, Merelbeke (BE)

(73) Assignee: Nuance Communications, Inc., Burlington, MA (US)

(21) Appl. No.: 14/798,698

(22) Filed: Jul. 14, 2015

(51) Int. Cl. G10L 15/06

(52) U.S. Cl. CPC G10L 15/063; G10L 2015/0635

(57) ABSTRACT

In some aspects, a method of updating a language model comprising probabilities associated with at least one variant name for each of a plurality of entities stored in a domain-specific database is provided. The method comprises receiving input from a user, determining whether content of the input matches the at least one variant name of any of the plurality of entities in the language model, and updating at least one probability of the language model based, at least in part, on the determination.

### BACKGROUND

Computer systems have been developed that receive input from a user and process the input to understand and respond to the user accordingly. Many such systems allow a user to provide free-form speech input, and are therefore configured to receive an utterance from a user and employ various resources, either locally or accessible over a network, to attempt to understand the content and intent of the user's utterance and respond by providing relevant information and/or by performing one or more desired actions or tasks based on the understanding of what the user uttered. For example, a user utterance may include an instruction such as a request (e.g., “Give me driving directions to 472 Commonwealth Avenue,” “Please recommend a nearby Chinese restaurant,” “Play Eleanor Rigby by the Beatles,” etc.), a query (e.g., “Where is the nearest pizza restaurant?” “Who directed Casablanca?” “How do I get to the Mass Pike from here?” “What year did the Rolling Stones release Satisfaction?” etc.), a command (e.g., “Make a reservation at House of Siam for five people at 8 o'clock,” “Play Iko Iko by the Dixie Cups,” etc.), or may include other types of instructions to which a user expects the system to meaningfully respond.

To operate correctly, such systems must ascertain what the user wants and endeavor to respond to the user in an appropriate manner. In many instances, the information that a user seeks is stored in a domain-specific database and/or the system may need to obtain information stored in such a database to respond to the user. For example, navigational systems available as on-board systems in a vehicle, stand-alone navigational devices and, increasingly, as a service available via a user's smart phone, typically utilize universal address / point-of-interest (POI) database(s) to provide directions to a location specified by the user (e.g., an address or other POI such as a restaurant or landmark). As another example, queries relating to music may be handled by querying a media database storing, for example, artist, album, title, label and/or genre information, etc., and/or by querying a database storing the user's music library.

Given the variety of ways a user may phrase an inquiry, robustly understanding user input is difficult and generally not satisfactorily achieved by conventional systems.

### SUMMARY

Some embodiments include a method of updating a language model comprising probabilities associated with at least one variant name for each of a plurality of entities stored in a domain-specific database, the method comprising receiving input from a user, determining whether content of the input matches the at least one variant name of any of the plurality of entities in the language model, and updating at least one probability of the language model based, at least in part, on the determination.

Some embodiments include at least one computer readable medium having encoded thereon instructions that, when executed by at least one processor, perform a method of updating a language model comprising probabilities associated with at least one variant name for each of a plurality of entities stored in a domain-specific database, the method comprising receiving input from a user, determining whether content of the input matches the at least one variant name of any of the plurality of entities in the language model, and updating at least one probability of the language model based, at least in part, on the determination.

Some embodiments include a system for updating a language model comprising probabilities associated with at least one variant name for each of a plurality of entities stored in a domain-specific database, the system comprising at least one computer configured to perform receiving input from a user, determining whether content of the input matches the at least one variant name of any of the plurality of entities in the language model, and updating at least one probability of the language model based, at least in part, on the determination.

### BRIEF DESCRIPTION OF DRAWINGS

Various aspects and embodiments of the application will be described with reference to the following figures. The figures are not necessarily drawn to scale.

FIG. 1 is a diagram of an illustrative computing environment in which some embodiments of the technology described herein may operate;

FIG. 2 is a diagram of an illustrative technique for updating a language model; and

FIG. 3 is an example of a computer system that may be used to implement techniques described herein.

### DETAILED DESCRIPTION

As discussed above, computer systems configured to respond to user instructions (e.g., requests, commands, queries, questions, inquiries, etc.) provided as free-form input face a wide variety of content that the computer system must be able to recognize and/or interpret to respond to the user in a useful manner. As used herein, free-form means that a user is generally unconstrained with respect to the structure and/or content of the provided input. As such, a user may provide input using natural conversational language that need not (but may) conform to any particular structure, format or vocabulary. Permitting free-form input allows a user to interact with a system without requiring a user to learn and abide by a limited structured way of communicating with the system.

However, conventional systems typically can cope with little variation in the manner in which a user references subject matter to which an input pertains. Because there are numerous ways that a user might phrase an inquiry, conventional systems are frequently unable to respond meaningfully to user input. A difficulty encountered by conventional systems arises when users reference subject matter differently than how a database relied upon by the system references this same subject matter. For example, in the context of a navigation system, users may refer to the Massachusetts Turnpike using any number of variants such as the Mass Pike, Mass Turnpike, Route 90, 1-90, Interstate 90, U.S. 90, etc. As another example, a user requesting information about the song “59^{th} Street Bridge Song,” or a user requesting a media player to play this song, may speak any number of variants on the song title, including variants on the official name such as “59^{th} Street Song,” “The Bridge Song,” etc., or may use the alternative name or a variant thereof, including “Feelin' Groovy,” “Feeling Groovy,” etc.

With respect to many domains, users often do not know the actual name of the entity or their recollection of the name may be incomplete. For example, with points of interest, a user may only possess the gist of the POI that the user is interested in obtaining information about. With respect to music, users may not know or may have forgotten the actual title and may refer to a song using a portion of the lyric such as the refrain, leading to wide variation on how users refer to subject matter in the music domain. Additionally, there are often colloquial names, short-hand references and other common variants to naming subject matter that users may be interested in inquiring about. In practically every domain of interest, users are likely to refer to the same subject matter using different variants. Thus, because of the prevalent use of variant names in systems that allow generally free-form input, conventional systems routinely perform unsatisfactorily when attempting to respond to user inquiries.

The inventors have recognized that the inability of conventional systems in this respect can be at least partially attributed to the fact that domain-specific databases that are utilized by the system do not themselves capture variations on how entities stored therein are referenced. In particular, entities recorded in the database may be referenced by a single name such that queries to the database using a variation on that name (referred to herein as a “variant name”) will not result in a match such that useful results are not produced. Moreover, language models (e.g., vocabularies, grammars, etc.) used by such systems to ascertain content in user input are often derived from the information stored in the associated domain-specific database(s) and, as a result, the language models also do not capture information on variant names. Consequently, user input referencing one or more entities using a variant name may fail to be recognized and/or correctly understood so that the system cannot meaningfully respond to the user input.

The inventors have recognized that building and using language models that capture variant names and probabilities associated with each variant name for entities stored in relevant domain-specific database(s) facilitates more robust and accurate response to user input, particularly, but not limited to, free-form speech input. According to some embodiments, language model probabilities associated with variant names are adjusted during operation based on actual references by users. As a result, the probabilities associated with variant names may reflect the frequency of use of the corresponding variant names. According to some embodiments, new variants provide by users are added to appropriate language models so that actual usage is reflected by the language models.

Following below are more detailed descriptions of various concepts related to, and embodiments of, methods and apparatus for responding to user input. It should be appreciated that various aspects described herein may be implemented in any of numerous ways. Examples of specific implementations are provided herein for illustrative purposes only. In addition, various aspects described in the embodiments below may be used individually or in any combination, and are not limited to the combinations explicitly described herein.

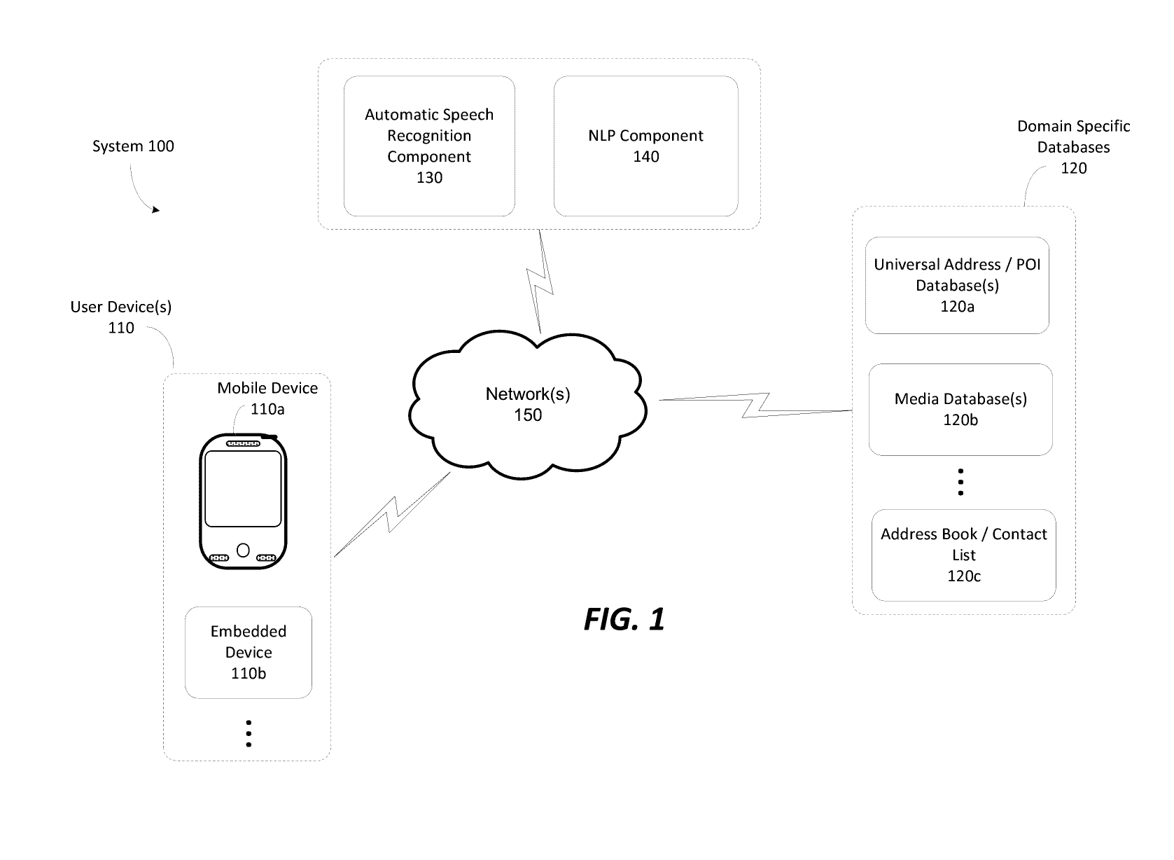

FIG. 1 illustrates a system 100 within which techniques described herein may be implemented. In particular, system 100 may be configured to receive, via any suitable user device 110, user input and process the user input to provide a response to the user. For example, a user device 110 may be a user's mobile device 110a (e.g., a smart phone, personal digital assistant (PDA), wearable device, navigational device, media player, vehicle on-board system, etc.) that allows the user to provide input, for example, using speech or via other suitable methods. User device 110 may include an embedded device 110b, such as one or more software and/or hardware components incorporated into an on-board vehicle system or as part of a media system (e.g., an entertainment system including a flat panel display, television, media and/or gaming capabilities, a vehicle's on-board entertainment and/or sound system, etc.). User device 110 may be any one or more computer devices configured to allow users to provide input, as the techniques described herein are not limited for use with any particular type of input device.

According to some embodiments, device 110 may include a user response system configured to obtain user input and, either alone or in conjunction with one or more network resources, process the user's input and provide a response to the user. The term “user response system” refers to any one or more software and/or hardware components deployed at least partially on or in connection with a user device (e.g., user device 110) that is configured to receive and respond to user input. A user response system may be specific to a particular application and/or domain (e.g., navigation, media, etc.), can be a general purpose system that responds to user input across multiple domains, or may be any other system configured to process user input to provide a suitable response (e.g., to provide information, perform one or more actions, etc.).

A user response system may be configured to access and utilize one or more network resources communicatively coupled to, or implemented as part of, the user response system via one or more networks 150, as discussed in further detail below. Thus, actions described as being performed by a user response system are to be understood as being performed local to user input device 110 and/or using any one or combination of network resources accessed, utilized or delegated to by the user response system, example resources of which are described in further detail below in connection with the system illustrated in FIG. 1. Thus, according to some embodiments, a user response system may be implemented as a distributed system having at least some functionality implemented on user device 110, and at least some functionality implemented via one or more network resources.

User device 110 often (though it need not necessarily) will include one or more wireless communication components. For example, user device 110 may include a wireless transceiver capable of communicating with one or more cellular networks. Alternatively, or in addition to, user device 110 may include a wireless transceiver capable of communicating with one or more other networks or external devices. For example, a wireless communication component of user device 110 may include a component configured to communication via the IEEE 802.11 standard (Wi-Fi) to connect to network access points coupled to one or more networks (e.g., local area networks (LANs), wide area networks (WANs) such as the internet, etc.), and/or may include a Bluetooth® transceiver to connect to a Bluetooth® compatible device, etc. Thus, user device 110 may include one or any combination of components that allow communication with one or more networks, systems and/or other devices. In some embodiments, the system may be self-contained and therefore may not need network access.

User device 110 further comprises at least one interface that allows a user to provide input to system 100. For example, user device 110 may be configured to receive speech from a user via one or more microphones such that the speech input can be processed (locally, via one or more network resources, or both) to recognize and understand the content of the speech, as discussed in further detail below. Alternatively, or in addition to, user device 110 may receive input from the user in other ways, such as via any one or combination of input mechanisms suitable for this purpose (e.g., touch sensitive display, keypad, mouse, one or more buttons, etc.).

Suitable user devices 110 will typically be configured to present one or more interfaces to provide information to the user. For example, user device 110 may display information to the user via a display, or may also provide information audibly to the user, for example, using speech synthesis techniques. According to some embodiments, information is provided to the user both visually and audibly and may include other mechanisms for providing information to the user, as the aspects are not limited for use with any particular type or technique for providing and/or rendering information to the user in response to user input. As discussed above, a response may be any information provided to a user and/or may involve performing one or more actions or tasks responsive to the input. The type of response provided will typically depend on the user input received and the type of user response system deployed.

According to some embodiments, a user response system implemented, at least in part, via user device 110 is configured to access, utilize and/or delegate to one or more network resources coupled to network(s) 150, and therefore may be implemented as a cloud-based user response system. Network(s) 150 may be any one or combination of networks interconnecting the various network resources including, but not limited to, any one or combination of LANs, WANs, the internet, private networks, personal networks, etc. The network resources depicted in FIG. 1 are merely exemplary, and a user response system may comprise any one or combination of network resources illustrated in FIG. 1, or may utilize other network resources not illustrated, as techniques described herein are not limited for use with any particular number or configuration of network resources. Among the benefits of a cloud-based solution is the ability to utilize user input from numerous users to improve system performance. In this respect, the system illustrated in FIG. 1 may service numerous user devices 110 receiving input from numerous users. Information gleaned from multiple users may be used to improve the performance of the system in responding to a wide variety of user input.

As discussed above, a user may utilize a user response system to make an inquiry of the system using speech. In this respect, to understand the nature of a user's speech input, such a voice response system may utilize automatic speech recognition (ASR) component 130 and/or natural language processing (NLP) component 140 that are configured to recognize constituent words and perform some level of semantic understanding (e.g., by classifying, tagging or other categorizing words in the speech input), respectively. Each of these components may be implemented in software, hardware, or a combination of software and hardware. Components implemented in software may comprise sets of processor-executable instructions that may be executed by one or more processors of one or more network computers, such as a network server or multiple network servers.

Each of ASR component 130 and NLP component 140 may be implemented as a separate component, or may be integrated into a single component or a set of distributed components implemented on one or multiple network computers (e.g., network servers). While ASR component 130 and NLP component 140 are illustrated as connected to user device 110 via network(s) 150, it should be appreciated that ASR component 130 and/or NLP component 140 may be implemented entirely on user device 110, partially on device 110 and partially via one or more network resources, or entirely via a network resource, as the techniques described herein are not limited for use to any particular implementation of these components.

The system illustrated in FIG. 1 also comprises a number of exemplary domain-specific databases 120. A domain-specific database refers to any collection of information relevant to a particular domain or multiple domains that is organized and accessible. Thus, a domain-specific database may be, for example, a relatively large database having hundreds, thousands or even millions of entries (e.g., a POI database), an address book or contact list stored on a user's mobile device (e.g., stored on user device 110), music titles in a user's music library (e.g., stored via iTunes), a film database (e.g., imdb.com), a travel database storing flight or hotel information, or may be any other suitable collection of information represented in any suitable manner. Entries in a database are referred to herein as “entities” and may include any information stored therein that can be queried or accessed via a query. For example, any populated instance of a field, record, entry, cell, or other construct can be an “entity” in the corresponding database.

In FIG. 1, the exemplary domain-specific databases include one or more universal address/POI database(s) 120a, which may be utilized for navigation assistance, one or more media databases, which can be utilized to respond to a user inquiries regarding music, film, etc. and/or one or more address or contact lists associated with the user. However, it should be appreciated that database(s) 120 illustrated in FIG. 1 and described above are merely examples and that techniques described herein may be applied in connection with any one or combination of databases that are available for querying, including network accessible databases and/or databases stored on or as part of a user device 110, as the aspects are not limited in this respect. For example, a navigation system may be coupled to an address/POI database while a general purpose “virtual assistant” may be coupled to multiple (sometimes numerous) domain-specific databases.

It should be further appreciated that the various components illustrated in FIG. 1 may be coupled in any suitable manner, and may be components that are located on the same physical computing system(s) or separate physical computing systems that can be coupled in any suitable way, including using any type of network, such as a local network, a wide area network, the internet, etc. For example, domain-specific databases may be network resources accessible via the network or may be stored, partially or entirely, on or as part of a user device 110. Similarly, when present, ASR component 130 and/or NLP component 140 may be implemented locally, remotely or a combination thereof, and may implemented as separate or integrated components.

According to some embodiments, a user may provide speech input to system 100 (e.g., by speaking to a voice response system operating, at least in part, on user device 110). When speech input is received, ASR component 130 may be utilized to identify the content of the speech (e.g., by recognizing the constituent words in the speech input). For example, a user may speak a free-form instruction to user device 110 such as “Give me driving directions to Billy Bob's Karaoke Hangout.” The speech input may be received by the voice response system and provided to ASR component 130 to be recognized. The free-form instruction may be processed in any suitable manner prior to providing the free-form instruction to ASR component 130. For example, the free-form instruction may be pre-processed to remove information, format the free-form instruction or modify the free-from instruction in preparation for ASR (e.g., the free-form instruction may be formatted to conform with a desired audio format and/or prepared for streaming as an audio stream or prepared as an appropriate audio file) so that the free-form instruction can be provided as an audio input to ASR component 130 (e.g., provided locally or transmitted over a network).

ASR component 130 may be configured to process the received audio input (e.g., audio input representing free-form instruction) to form a textual representation of the audio input (e.g., a textual representation of the constituent words in the free-form instruction that can be further processed to understand the meaning of the speech input) or any other suitable representation of the content of the speech input. According to some embodiments, ASR component 130 may be tailored, at least in part, to one or more specific domains. For example, ASR component may make use of a language model (which may be part of, or in addition to, another more general speech recognition lexicon) built in part from one or more domain specific databases with which the system is designed to operate. For example, ASR component 130 may be adapted to recognize addresses and/or POIs by utilizing a language model derived, at least in part, from entities stored in the universal address/POI database 120a. Similarly, ASR component 130 may be adapted to recognize speech input related to music by utilizing a language model derived from entities stored in media database 120b. It should be appreciated that language models may be derived from any one or more desired domain-specific databases to configure ASR component 130 to the corresponding domain. It should be further appreciated that a language model used by ASR component 130 (or any of the other network resources) may be implemented and/or represented in any suitable way (e.g., as a vocabulary, grammar, statistical model, neural network, HMM, etc.), as the aspects are not limited for use with any particular type of language model representation.

ASR component 130 may transmit or otherwise provide the recognized input to a NLP component 140 to assist in understanding the semantic content of the user's input. For example, NLP component 140 may use any suitable language understanding techniques to ascertain the meaning of the user input so as to facilitate responding to the user (e.g., in determining driving directions to the requested locale and providing the driving directions to the user). For example, NLP component 140 may be configured to identify and extract grammatical and/or syntactical components of the free-form speech, such as parts of speech, or words or phrases belonging to known semantic categories, to facilitate an understanding of the user inquiry. NLP component 140 may, or another component may use information from NLP component 140 to, tag words or phrases in the recognized speech input that are pertinent to categories (e.g., fields, records, entries, cells) of a relevant domain specific database so that the domain-specific database can be effectively queried.

In the example give above, NLP component 140 may identify action words, subject words, topic words, entities that appear in one or more domain-specific databases, and/or any other type or category of words the NLP component 140 may deem relevant to ascertaining the semantic form or content of the user inquiry to facilitate providing a meaningful response to the user. NLP component 140 may also identify words as not being relevant to the substance of the speech input such as certain filler words, carrier phrases, etc.

NLP component 140 also may be used to process the recognized input to identify the domain to which the user input pertains. For example, NLP component 140 may use knowledge representation models that capture semantic knowledge regarding language and that may be capable of associating terms in the recognized request with corresponding categories, classifications or types so that the domain of the request can be identified. With reference to the above described example speech input, NLP component 140 may ascertain from knowledge of the meaning of the terms “driving” and/or “directions” that the user's inquiry pertains to navigation and/or NLP component 140 may identify “Billy Bob's Karaoke Hangout” as a POI, thereby providing information to the system that the universal address/POI database(s) 120a is likely relevant in responding to the user's request. For systems that operate in only one domain, there may be no need to specifically identify the domain to which the user input pertains.

Based on the information provided by ASR component 130 and/or NLP component 140, the system (e.g., a voice response system) may transform the recognized input into one or more queries to the corresponding domain-specific database to obtain information to facilitate responding to the user. Referring again to the above exemplary user input, the information provided by ASR component 130 and/or NLP component 140 may be used to conclude that the user is requesting driving directions to the specified POI. The recognized request can be transformed into one or more queries to universal address/POI database 120a to obtain the geographical location of Billy Bob's Karaoke Hangout so that directions can be computed and provided to the user. Similarly, a user providing speech input with the inquiry “What is the address of Billy Bob's Karaoke Hangout?” may be likewise processed and a query to database 120a provided to obtain the address of the POI of interest to return to the user. Such processing can be used to respond to user input in any number of domains to which the system is configured to operate.

Many databases store a single “de facto” name for entities stored therein. Provided that the manner in which a user refers to the entity of interest matches the de facto name of that entity as it appears in the corresponding domain-specific database, a conventional system may be able to meaningfully respond to the user inquiry. For example, provided “Billy Bob's Karaoke Hangout” is the de facto name stored in POI database 120a, a conventional system has the possibility of recognizing the POI and forming a productive query to the database to facilitate responding to the user. However, it is often the case that a user speaks a variant of an entity that is stored in a corresponding domain-specific database. In the example discussed above, users may refer to the entity whose de facto name is “Billy Bob's Karaoke Hangout” using any number of variant names, for example, “Bob's Karaoke Hangout,” “Bob's Karaoke,” “BBs Singalong,” “The Karaoke Hangout,” etc. Conventional systems are frequently unable to respond to a user that refers to one or more entities using a variant name instead of the de facto name.

As discussed above, the inventors have recognized that the failure of conventional systems to cope with variant names often results from the fact that domain-specific databases typically only have a de facto name of the entity, giving rise to numerous possible points of failure in the process described above. In particular, because language models used by either ASR or NLP components, or both, are often derived from the corresponding domain-specific database, the language models also may only capture information in connection with the de facto name.

As a result, ASR components that utilize a language model derived from information in a domain-specific database that stores de facto names but does not capture variant names may not correctly recognize speech from a user who speaks a variant name. Additionally, an NLP component that utilizes a language model derived from such a domain-specific database may fail to correctly identify, classify, tag or otherwise categorize a variant name, even should ASR manage to correctly recognize the constituent words. Finally, even in instances where ASR and NLP recognize and identify content correctly, because the corresponding domain-specific database does not capture variant names, when the database is queried with a variant name, no match may be found, and the database may fail to produce results that can be used to respond to the user. Accordingly, user inquiries that include variants names present significant challenges for conventional systems, such as conventional user response systems.

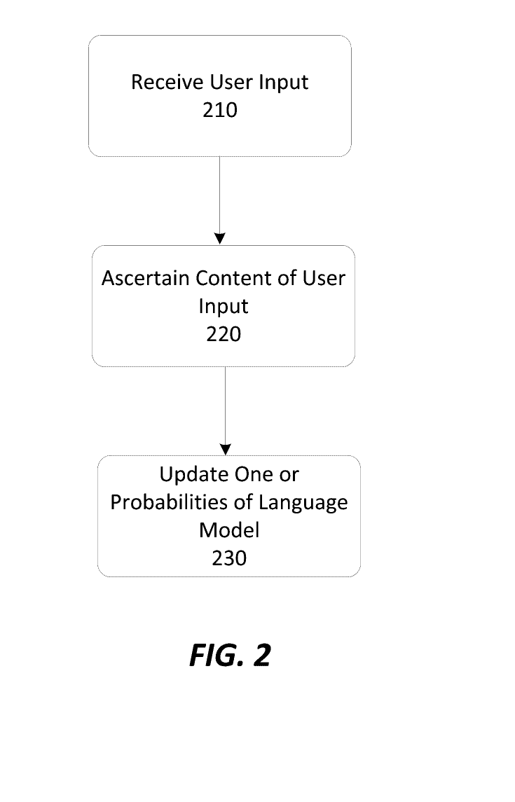

As discussed above, the inventors have developed techniques that both handle user references to entities using variant names and dynamically adjust statistics on their use, for example, by updating language models based on how users actually refer to entities in practice. FIG. 2 illustrates a method for providing user response capabilities in circumstances where received user inquiries include variant names for referenced entities, in accordance with some embodiments. In act 210, user input is received from a user. The user input may be a free-form instruction input from the user as speech or input in any other suitable manner (e.g., as text via a keypad, touchscreen, etc.). For example, the user may request information by speaking to the system. Alternatively, or in addition to, the user may provide input to the system in other ways such as by typing a request (e.g., typing an address or a POI into the system), selecting options from a display (e.g., selecting an option from a menu, clicking or touching a location on a displayed map, etc.) and/or providing input in any other suitable way, as the techniques described herein are not limited for use with any particular type or combination of types of input.

In act 220, content of the user inquiry is automatically ascertained. For example, when the user input comprises speech input, the speech input may be processed using ASR to recognize the constituent words of the speech input. To do so, ASR may use a language model comprising probabilities associated with at least one variant name for each of a plurality of entities, the plurality of entities stored in one or more domain-specific databases. For example, the language model may associate a probability with each de facto name and each variant name for entities stored in a corresponding domain-specific database, wherein each probability is indicative of an actual or approximate frequency that users refer to the respective entity using the respective name. Any probability, statistic or likelihood measure may be used to provide an indication of frequency of use and/or likelihood that the respective name is used. By using a language model that represents and/or captures probabilities on variant names, the likelihood that the user's speech input will be correctly recognized may be improved.

According to some embodiments, the user input may be processed using NLP to understand the meaning of the user input. In circumstances where the user input comprises speech and ASR is used to recognize the speech, the recognized speech input may be processed using NLP. In other circumstances wherein the user input is provided in other manners, for example, as text input, the user input may be processed using NLP without first being processed by ASR. NLP may use a language model that represents or captures information on variant names for a plurality of entities stored in one or more domain-specific databases to assist in identifying, classifying, tagging and/or categorizing words or phrases in the user input, or to otherwise ascertain the meaning or nature of the user input so as to meaningfully respond to the user. However, NLP may classify or provide information about the meaning of the user input without the use of such a language model, as the aspects are not limited in this respect. To respond to user input, it may be necessary to obtain information from one or more domain-specific databases. When a user response system serves multiple domains, NLP may be used to identify which domain the user input pertains. Information provided by NLP (or otherwise determined) may be used to produce one or more queries to relevant domain-specific database(s) based on the content of the user input ascertained by ASR and/or NLP.

As part of ascertaining content of the user input in act 220, ASR and/or NLP may determine whether content of the user input matches either a de facto name or a variant name of any of the plurality of entities represented in the language model. In this manner, the voice response system may be better equipped to handle the variety of ways in which a user may reference entities to which their input pertains. The language model may be part of, integrated with or separate from one or more other language models utilized by ASR and/or NLP. In particular, it should be appreciated that one or more other language models may be used to assist in various tasks such as recognizing large vocabulary words, identifying carrier phrases such as “Please give me directions . . . ”, identify parts of speech, perform semantic tagging, etc. These language models may be separate from or integrated with (e.g., the same as) the language model that represents information on de facto and variant names and may be stored in the same location or distributed in any manner, as the aspects are not limited in this respect.

In act 230, one or more probabilities of the language model are updated as a result of matching content of the user input to a de facto name or a variant name of at least one entity. For example, if content in the user input is matched to a variant name, a probability associated with the matched variant name may be increased. Similarly, if content in the user input is matched to a de facto name, a probability associated with the matched de facto name may be increased. According to some embodiments, when a probability associated with a de facto name or a variant name is increased, probabilities associated with one or more other names for that entity may be correspondingly decreased, for example, to achieve normalization. However, any method by which probabilities associated with names of entities stored in one or more databases are adjusted or modified based on user input may be used (e.g., based on identifying use of a de facto or variant name in user speech), as the aspects are not limited for use with any particular technique for doing so.

In connection with the example described above, assume that “Billy Bob's Karaoke Hangout” is the de facto name of an entity in a POI database. A language model may capture the following probabilities with respect to the de facto name and a number of variant names. The probabilities may have been arrived at over the course of receiving user input referencing this entity in a variety of ways, either from a single user or from multiple users of a system (e.g., a cloud-based system). As such, the language model may capture statistics on the frequency of use for the various ways in which user(s) reference this POI.

TABLE 1

| Name | Probability |
|---|---|
| Billy Bob's Karaoke Hangout | .2 |
| Billy Bob's Karaoke | .4 |
| Bob's Karaoke | .25 |
| BB's Singalong | .1 |
| The Karaoke Hangout | .05 |

When subsequent user input is received and determined to include content referencing this entity using the de facto name or a variant name, one or more of the probabilities may be adjusted to account for this occurrence. For example, if a user speaks the utterance “What is the address for Billy Bob's Karaoke?”, the system may ascertain that the user has referenced this entity using a variant name and may increase the probability for this variant name accordingly (e.g., increase the probability from 0.4 to a higher probability). According to some embodiments, the probabilities associated with the de facto name and the other variant names may be decreased as well so that the total probability remains unity. However, in other representations, not all of the probabilities need be adjusted and, in some cases, no probabilities are adjusted based on the occurrence of a user referencing the entity.

A language model having information on variant names may be populated in a number of ways. For example, the language model for the above described entity may initially consist of the de facto name (Billy Bob's Karaoke Hangout) as found in the corresponding domain-specific database. Because no variants may initially be available, the de facto name may have an associated probability of one or close to one, although any suitable probability may be chosen. The language model may then be populated with variants in any suitable way, including manually or automatically seeding the language model with variant names (e.g., via human participation, using preexisting information, generating permutations of the de facto name, etc.), obtaining variant names from users during operation, or any combination thereof, as discussed in further detail below.

Because a system may initially have difficulty recognizing variant names for the reasons that conventional systems frequently fail, populating the language model from user input may, in some embodiments, require some initial intervention. For example, when a system fails to recognize content in user input with sufficient confidence and/or the system fails to match recognized content with any entity in a relevant domain specific-database, the system may query the user to determine what entity the user was referring to (e.g., the system may perform a dialog sequence with the user to determine what entity the user was referencing). Based on the answers to the question, the system, with or without the assistance of a human, may determine what entity the user was referring to and update the language model for that entity with the variant name used by the user. The dialog with the user may be performed using speech (e.g., using synthesize speech via text-to-speech synthesis or prerecorded queries) or via a written dialog (e.g., prompts, dialog boxes, menus, etc.), as the manner of implementing the dialog is not a limitation.

According to some embodiments, a new variant name is identified when a user accepts a result presented to the user by the system. For example, the system may present a number of possibilities (e.g., a number of possible de facto names corresponding to what the user spoke) to the user and when the user selects one of the possibilities, the new variant name is recorded as a variant of the selected possibility. In other embodiments, the response to the user may be one or more actions and when the user does not respond negatively to the action (e.g., uses the provided navigation directions, listens to the song played by the system, etc.), the system may accept as a new variant the words spoken by the user. Other techniques to identify and accept a new variant name may be used as well, as the aspects are not limited in this respect.

Alternatively, or in addition to, a human transcriptionist may transcribe user input and determine what entity the user was referring to and update the language model accordingly without necessarily asking the user to answer questions. For example, a human reviewer may be employed to review audio and/or recognition results (automatic transcripts) associated with user input that is newly received, is indicated as incomplete, was flagged as having a low recognition confidence, etc. In the course of listening to the audio and/or reviewing the recognition results, the reviewer may determine that the user spoke a variant name and may update the language model to reflect its use, e.g., either by updating the statistics regarding a recorded variant name or adding the variant name to the language model if it is not currently recorded. A human reviewer may perform other tasks and may update a language model in other ways, as the aspects are not limited in this respect.

Another technique for populating a language model involves automatically or manually generating variant names, or using a combination of automated and manual techniques. For example, one method of automatically populating the language model would be to permute the words in the de facto name of the entity obtained from the corresponding domain-specific database. While this technique has the advantage of being automated, it has some drawbacks. For example, variant names that users actually use to refer to entities are often not mere permutations of the de facto name. As a result, a language model may be populated with variants that are never actually used. Additionally, generating numerous variant names in this respect may in fact negatively impact recognition accuracy as it increases the likelihood that a variant name sounds similar to a different entity, thereby resulting higher rates of misrecognitions. Automatically generated variant names may, for example, each be given the same or similar probabilities at the outset, though this is not a requirement as automatically generated variant names may be assigned any suitable probability. New variant names arising from user input can be added to the language model during operation using any of the techniques discussed above, or by using any other suitable technique.

Manual techniques may include having a human populate the language model based, for example, on expertise in the particular domain and/or by using any available data on how users reference particular entities to assist in populating the language model with variant names and assigning the variant names a probability. However, involving a human to populate language models, particularly for domain-specific databases that have records for large numbers of entities (e.g., a universal address/POI database that may have hundreds, thousands or even millions of entries) can be time intensive. A combination of automated and manual techniques may also be used to take advantage of the benefits of both techniques while mitigating potential drawbacks. For example, a user might review automatically generated variant names and edit, omit and/or add variant names as deemed appropriate. It should be appreciated that a language model may be initially populated with variant names and associated probabilities in other ways, as the aspects are not limited in this respect.

According to some embodiments, variant names in the language model may be removed by the system during operation. For example, if a variant name retains or obtains a low probability because the corresponding entity is not being referenced by users with the particular variant name, the system may remove the variant name to avoid the variant name potentially causing misrecognitions, as well as to reduce computation time in considering the variant name during processing. For example, variant names that have only a single incident of use, a low number of uses and/or use by a single user in a multiple user environment after having been recorded for some reasonable amount of time may be pruned from the language model to avoid cluttering the language model with variant names that may be unique to a single user and/or that occur too infrequently to maintain in the language model. Any technique for pruning using any desired criteria may be used, as the aspects are not limited in this respect.

As discussed above, a user response system that receives and processes user input to provide information in response may be a cloud-based solution so that user input from multiple users may be used to improve system performance. For example, user input received from any number of users via any number of respective user devices may be used to update the probabilities associated with de facto and variant names of entities stored by any number of databases. Together, this information may quickly provide accurate (and updated) statistics how multiple users are referring to pertinent entities, as well as providing a mechanism to efficiently gather information on new variant names that can be added to the language models.

User input can be used individually (e.g., in single-user environments) or together in any suitable manner. For example, user input from multiple users of the same system (e.g., multiple users of the same vehicle navigation system) may be used to update language model(s) to assist in improving system performance. As another example, input from users in a specified group, for example, input from all users within a particular region may be used to update language model(s) to facilitate improving understanding of user input. In other cases, there may be different groupings and/or no restrictions at all placed on the user input used to update language model(s), as the techniques described herein are not limited for use to any particular manner of using user input and/or aggregating such user input.

Updates may be distributed in any suitable manner. For systems that utilize network ASR and/or NLP, updated language models may be immediately available as they are updated in real-time, near-real time or on a periodic schedule. For systems that utilize local ASR and/or NLP, updated language models may be periodically downloaded to the system as deemed necessary. Updates may be downloaded upon request of the user, or the cloud may push updates to relevant systems, either by downloading the update automatically (e.g., without user knowledge and/or intervention) or by prompting the user and downloading upon the user indicating that the update is desired. Language models may be stored separately and/or as part of corresponding domain-specific database(s), as the aspects are not limited in this respect.

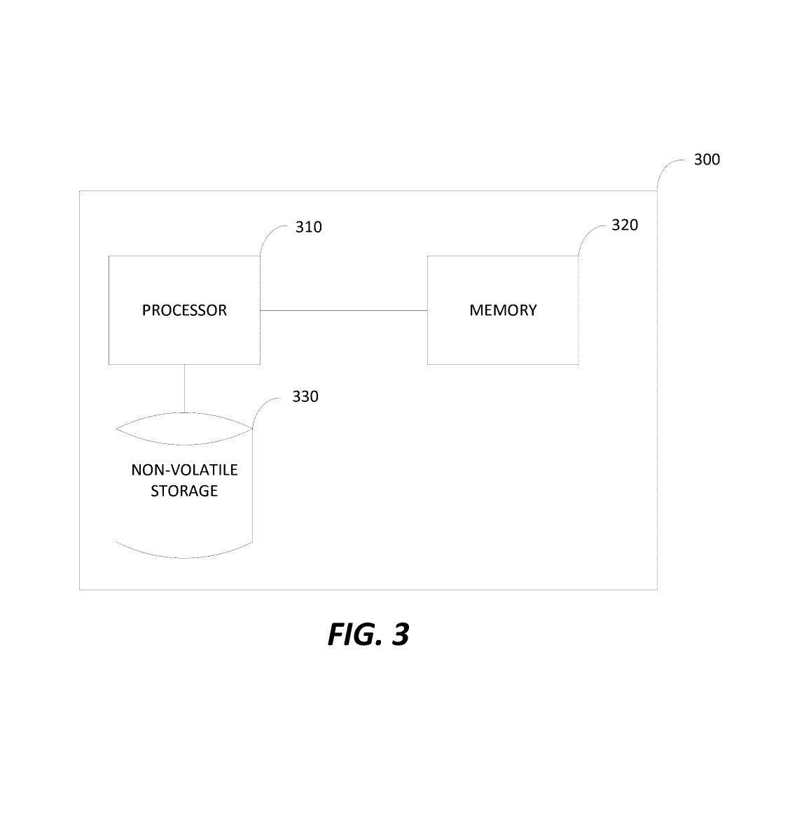

An illustrative implementation of a computer system 300 that may be used to implement one or more of the techniques described herein is shown in FIG. 3. For example, a computer system 300 may be used to implement one or more components illustrated in FIG. 1 and/or to perform one or more techniques described in connection with FIG. 2. Computer system 300 may include one or more processors 310 and one or more non-transitory computer-readable storage media (e.g., memory 320 and one or more non-volatile storage media 330). The processor 310 may control writing data to and reading data from the memory 320 and the non-volatile storage device 330 in any suitable manner, as the aspects of the invention described herein are not limited in this respect. Processor 310, for example, may be a processor on a mobile device, a personal computer, a server, an embedded system, etc.

To perform functionality and/or techniques described herein, the processor 310 may execute one or more instructions stored in one or more computer-readable storage media (e.g., the memory 320, storage media, etc.), which may serve as non-transitory computer-readable storage media storing instructions for execution by processor 310. Computer system 300 may also include any other processor, controller or control unit needed to route data, perform computations, perform I/O functionality, etc. For example, computer system 300 may include any number and type of input functionality to receive data and/or may include any number and type of output functionality to provide data, and may include control apparatus to perform I/O functionality.

In connection with processing received user input, one or more programs configured to receive user input, process the input or otherwise execute functionality described herein may be stored on one or more computer-readable storage media of computer system 300. In particular, some portions or all of a user response system, such as a voice response system, configured to receive and respond to user input may be implemented as instructions stored on one or more computer-readable storage media. Processor 310 may execute any one or combination of such programs that are available to the processor by being stored locally on computer system 300 or accessible over a network. Any other software, programs or instructions described herein may also be stored and executed by computer system 300. Computer system 300 may represent the computer system on user input device and/or may represent the computer system on which any one or combination of network components are implemented (e.g., any one or combination of components forming a user response system, or other network resource). Computer system 300 may be implemented as a standalone computer, server, part of a distributed computing system, and may be connected to a network and capable of accessing resources over the network and/or communicate with one or more other computers connected to the network (e.g., computer system 300 may be used to implement any one or combination of components illustrated in FIG. 1).

The terms “program” or “software” are used herein in a generic sense to refer to any type of computer code or set of processor-executable instructions that can be employed to program a computer or other processor to implement various aspects of embodiments as discussed above. Additionally, it should be appreciated that according to one aspect, one or more computer programs that when executed perform methods of the disclosure provided herein need not reside on a single computer or processor, but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in one or more non-transitory computer-readable storage media in any suitable form. For simplicity of illustration, data structures may be shown to have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

Also, various inventive concepts may be embodied as one or more processes, of which multiple examples have been provided. The acts performed as part of each process may be ordered in any suitable way. Accordingly, embodiments may be constructed in which acts are performed in an order different than illustrated, which may include performing some acts concurrently, even though shown as sequential acts in illustrative embodiments.

All definitions, as defined and used herein, should be understood to control over dictionary definitions, and/or ordinary meanings of the defined terms.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

What is claimed is:

1. A method of updating a language model comprising probabilities associated with at least one variant name for each of a plurality of entities stored in a domain-specific database, the method comprising:
receiving input from a user;
determining whether content of the input matches the at least one variant name of any of the plurality of entities in the language model; and
updating at least one probability of the language model based, at least in part, on the determination.

2. The method of claim 1, wherein the input comprises speech input, and wherein determining comprises performing automatic speech recognition on the speech input using the language model to recognize at least some words in the speech input.

3. The method of claim 2, further comprising, when content of the input is matched to a de facto name or a variant name associated with one of the plurality of entities, querying the domain-specific database using the de facto name to obtain information about the one of the plurality of entities.

4. The method of claim 2, further comprising, when content of the input is matched to a de factor name or a variant name associated with one of the plurality of entities, querying the domain-specific database using a variant name to obtain information about the one of the plurality of entities.

5. The method of claim 2, wherein the probabilities comprise a probability associated with each de facto name and each variant name of each of the plurality of entities, each probability being indicative of a frequency that users refer to the respective entity using the respective name.

6. The method of claim 5, wherein content of the input matches a variant name of one of the plurality of entities, and wherein updating the at least one probability comprises increasing the probability associated with the matched variant name.

7. The method of claim 6, wherein updating the at least one probability comprises adjusting the probability associated with the de facto name and each of the at least one variant names of the one of the plurality of entities.

8. The method of claim 5, wherein content of the input matches the de facto name of one of the plurality of entities, and wherein updating the at least one probability comprises increasing the probability associated with the de facto name.

9. The method of claim 8, wherein updating the at least one probability comprises adjusting the probability associated with each of the at least one variant names of the one of the plurality of entities.

10. The method of claim 2, wherein, when content of the speech input is not successfully matched using the language model, a new variant name is added to the language model, the new variant name associated with one of the plurality of entities.

11. The method of claim 10, wherein the new variant name corresponds to content of the speech input recognized either automatically or by a human transcriber.

12. The method of claim 10, wherein the one of the plurality of entities to which the new variant name is associated is identified, at least in part, by asking the user at least one question regarding the content of the input.

13. The method of claim 2, further comprising performing natural language processing on at least some of the recognized words to identify one or more words pertinent to the domain-specific database.

14. The method of claim 13, further comprising forming at least one query to the domain-specific database using the one or more identified words.

15. The method of claim 1, wherein the plurality of entities comprise addresses and/or points-of-interest.

16. The method of claim 1, wherein the plurality of entities are associated with a media domain.

17. The method of claim 15, wherein the plurality of entities comprise song titles, artists and/or albums.

18. The method of claim 15, wherein the plurality of entities comprise film titles, actors and/or directors.

19. At least one computer readable medium having encoded thereon instructions that, when executed by at least one processor, perform a method of updating a language model comprising probabilities associated with at least one variant name for each of a plurality of entities stored in a domain-specific database, the method comprising:
receiving input from a user;
determining whether content of the input matches the at least one variant name of any of the plurality of entities in the language model; and
updating at least one probability of the language model based, at least in part, on the determination.

20. A system for updating a language model comprising probabilities associated with at least one variant name for each of a plurality of entities stored in a domain-specific database, the system comprising:
at least one computer configured to perform:
receiving input from a user;
determining whether content of the input matches the at least one variant name of any of the plurality of entities in the language model; and
updating at least one probability of the language model based, at least in part, on the determination.
